(19) United States
(12) Patent Application Publication
(10) Pub. No.: US 2020/0398679 A1
(43) Pub. Date: Dec. 24, 2020

(54) WORK VEHICLE WITH CONSTANT OUTPUT ALTERNATOR ASSEMBLY

(71) Applicant: CNH Industrial America LLC, New Holland, PA (US)

(72) Inventor: Steven H. Siefken, Muscatine, IA (US)

(73) Assignee: CNH Industrial America LLC, New Holland, PA (US)

(21) Appl. No.: 16/447,265

(22) Filed: Jun. 20, 2019

(51) Int. Cl. B60L 50/10; F16H 55/36

(52) U.S. Cl. CPC B60L 50/10; F02D 31/001; F16H 55/36

(57) ABSTRACT

An alternator assembly includes: an alternator having an alternator input; a variable transmission assembly including an input pulley, an output pulley coupled to the input pulley and the alternator input, and a solenoid configured to adjust a gear ratio between the input pulley and the output pulley; a rotation speed sensor coupled with at least one of the output pulley or the alternator input and configured to output a first signal; and a controller. The controller is configured to determine the rotation speed of the alternator input based on the first signal; compare the rotation speed of the alternator input to a set rotation speed; and output an adjustment signal if the rotation speed of the alternator input differs from the set rotation speed so the solenoid adjusts the gear ratio such that the rotation speed of the alternator input is equal to the set rotation speed.

### FIELD OF THE INVENTION

The present invention pertains to work vehicles and, more specifically, to work vehicles with alternators.

### BACKGROUND OF THE INVENTION

Work vehicles, e.g., tractors, harvesters, skid steers, etc., generally include an electrical system that powers various components of the work vehicle. The electrical system includes an alternator and a battery electrically coupled to the alternator. The alternator is mechanically coupled to output of a prime mover, such as an engine, to convert mechanical power output by the engine into electrical power that keeps the battery charged and the components powered. With work vehicles incorporating electrical components that require increasing amounts of electrical power, the demands on the electrical system have grown significantly.

What is needed in the art is a work vehicle that can provide sufficient electrical power for electrical components of the work vehicle.

### SUMMARY OF THE INVENTION

Exemplary embodiments disclosed herein provide a variable transmission assembly coupled to an alternator and a controller that is configured to control at least one solenoid to adjust a gear ratio of the variable transmission assembly if a rotation speed of an alternator input is different than a set rotation speed.

In some exemplary embodiments provided in accordance with the present disclosure, an alternator assembly for a work vehicle includes: an alternator having an alternator input, the alternator being configured to convert rotational motion of the alternator input into electrical current; a variable transmission assembly including an input pulley, an output pulley coupled to the input pulley and the alternator input, and at least one solenoid configured to act on at least one of the input pulley or the output pulley to adjust a gear ratio between the input pulley and the output pulley; a rotation speed sensor coupled with at least one of the output pulley or the alternator input and configured to output a first signal corresponding to a rotation speed of the alternator input; and a controller operatively coupled to the at least one solenoid and the rotational speed sensor. The controller is configured to: receive the output first signal; determine the rotation speed of the alternator input based on the received first signal; compare the rotation speed of the alternator input to a set rotation speed; and output an adjustment signal to the at least one solenoid if the rotation speed of the alternator input differs from the set rotation speed so the at least one solenoid adjusts the gear ratio such that the rotation speed of the alternator input is equal to the set rotation speed.

In some exemplary embodiments provided in accordance with the present disclosure, a work vehicle includes: a chassis; an engine carried by the chassis and having an engine output shaft; a battery carried by the chassis; an alternator electrically coupled to the battery and having an alternator input, the alternator being configured to convert rotational motion of the alternator input into electrical current that is output to the battery; a variable transmission assembly including an input pulley coupled to the engine output shaft, an output pulley coupled to the input pulley and the alternator input, and at least one solenoid configured to act on at least one of the input pulley or the output pulley to adjust a gear ratio between the input pulley and the output pulley; a rotation speed sensor coupled with at least one of the output pulley or the alternator input and configured to output a first signal corresponding to a rotation speed of the alternator input; and a controller operatively coupled to the at least one solenoid and the rotational speed sensor. The controller is configured to: receive the output first signal; determine the rotation speed of the alternator input based on the received first signal; compare the rotation speed of the alternator input to a set rotation speed; and output an adjustment signal to the at least one solenoid if the rotation speed of the alternator input differs from the set rotation speed so the at least one solenoid adjusts the gear ratio such that the rotation speed of the alternator input is equal to the set rotation speed.

In some exemplary embodiments, a method for maintaining electrical current output of an alternator of a work vehicle is provided. The alternator includes an alternator input that is coupled to an output pulley of a variable transmission assembly, the output pulley being coupled to an input pulley. The method is performed by a controller and includes: receiving a first signal from a rotation speed sensor coupled to at least one of the output pulley or the alternator input, the first signal corresponding to a rotation speed of the alternator input; determining the rotation speed of the alternator input based on the received first signal; comparing the rotation speed of the alternator input to a set rotation speed; and outputting an adjustment signal to at least one solenoid if the rotation speed of the alternator input differs from the set rotation speed so the at least one solenoid adjusts a gear ratio between the input pulley and the output pulley such that the rotation speed of the alternator input is equal to the set rotation speed.

One possible advantage that may be realized by exemplary embodiments disclosed herein is that the alternator input may be continuously rotating at a set rotation speed so the electrical current output of the alternator is consistent.

Another possible advantage that may be realized by exemplary embodiments disclosed herein is that the set rotation speed may be a rotation speed at which the alternator outputs a maximum electrical current so the alternator output is always maximized regardless of the engine rotation speed.

### BRIEF DESCRIPTION OF THE DRAWINGS

For the purpose of illustration, there are shown in the drawings certain embodiments of the present disclosure. It should be understood, however, that the invention is not limited to the precise arrangements, dimensions, and instruments shown. Like numerals indicate like elements throughout the drawings. In the drawings:

FIG. 1 illustrates a side view of an exemplary embodiment of a work vehicle, the work vehicle comprising a chassis, an alternator, a variable transmission assembly, and a controller, in accordance with an exemplary embodiment of the present disclosure;

FIG. 2 illustrates a cross-section of the variable transmission assembly of FIG. 1, in accordance with an exemplary embodiment of the present disclosure;

FIG. 3 is a flow chart illustrating a method for maintaining electrical current output of an alternator of a work vehicle, in accordance with an exemplary embodiment of the present disclosure; and

FIG. 4 is a flow chart illustrating a method for maintaining electrical current output of an alternator of a work vehicle, in accordance with an exemplary embodiment of the present disclosure.

### DETAILED DESCRIPTION OF THE INVENTION

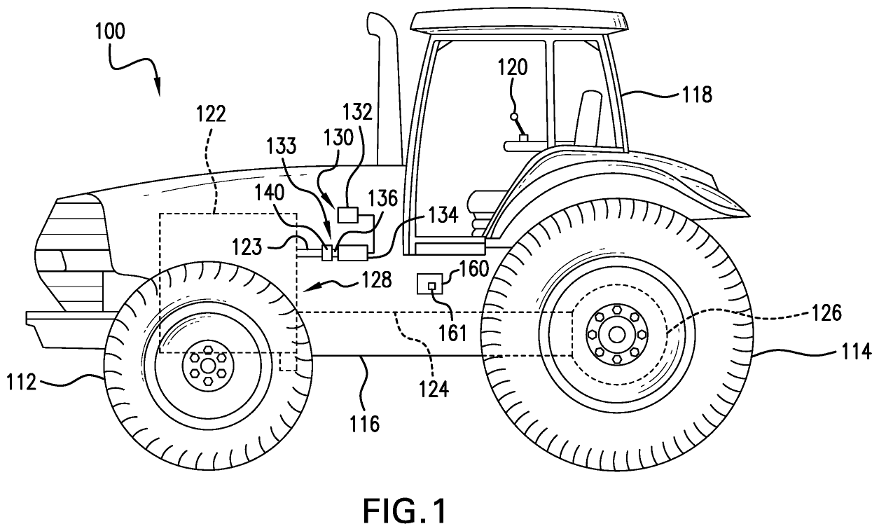

Referring now to the drawings, and more particularly to FIG. 1, an exemplary embodiment of a work vehicle 100 is illustrated. As shown, the work vehicle 100 is configured as an agricultural tractor. However, in other embodiments, the work vehicle 100 may be configured as any other type of work vehicle, such as various other agricultural vehicles, earth-moving vehicles, road vehicles, loaders and/or the like.

As shown in FIG. 1, the work vehicle 100 includes a pair of front wheels 112, a pair or rear wheels 114 and a chassis 116 coupled to and supported by the wheels 112, 114. An operator cab 118 may be supported by a portion of the chassis 116 and may house various control devices 120 (e.g., levers, pedals, control panels and/or the like) for permitting an operator to control the overall operation of the work vehicle 100. Additionally, the work vehicle 100 includes an engine 122 having an engine output shaft 123 and a transmission 124 mounted on the chassis 116. The transmission 124 may be operably coupled to the engine 122 and may provide variably adjusted gear ratios for transferring engine power to the wheels 114 via a differential 126. The engine 122, transmission 124, and differential 126 may collectively define a drive train 128 of the work vehicle 100.

The work vehicle 100 includes an electrical system 130 that includes a battery 132 carried by the chassis 116 and an alternator assembly 133 including an alternator 134 electrically coupled to the battery 132. As is known, various components can be electrically coupled to the battery 132 to receive electrical power needed for operation. The alternator 134 is configured to convert rotational motion of an alternator input 136 into electrical current that is output to the battery 132. As illustrated, the alternator input 136 is a shaft, but it should be appreciated that the alternator input 136 can be a different type of rotatable element, such as a chain.

To rotate the alternator input 136 and produce electrical current, a variable transmission assembly 140 is provided that links rotational motion of the engine output shaft 123 to the alternator input 136. The variable transmission assembly 140 may, for example, be directly coupled to the engine output shaft 123. The engine output shaft 123 transmits power from the engine 122 to the variable transmission assembly 140, which then transmits power to the alternator input 136 to produce electrical current.

In known alternator assemblies, the electrical output of the alternator depends on the rotation speed of the engine. As the demands on the electrical systems of work vehicles increase, it has been found that the alternator is sometimes unable to provide sufficient electrical power to operate all of the electrical components of the work vehicle. This insufficiency can be especially pronounced when the engine is idling, which represents the lowest rotation speed of the engine. Thus, some work vehicles lose functionality of one or more electronic components at idle because there is insufficient electrical power to operate all of the electronic components.

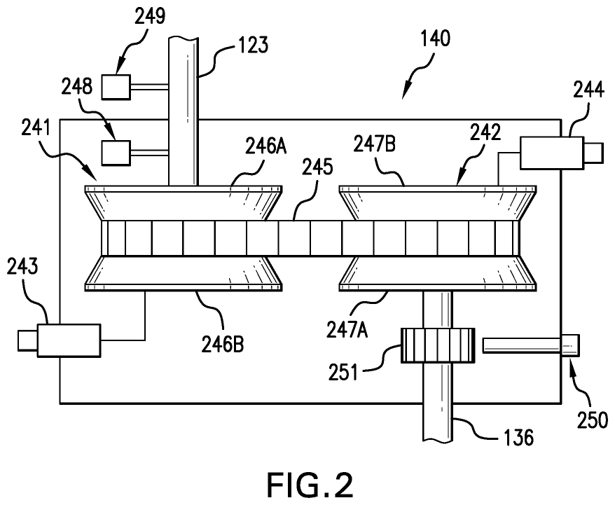

To reduce the risk of low engine speed resulting in insufficient electrical power, and referring now to FIG. 2, the variable transmission assembly 140 formed according to the present disclosure is provided. The variable transmission assembly 140 generally includes an input pulley 241 coupled to the engine output shaft 123, which may also be referred to as a “transmission input,” an output pulley 242 coupled to the input pulley 241 and the alternator input 136, and at least one solenoid, illustrated as a first solenoid 243 coupled to the input pulley 241 and a second solenoid 244 coupled to the output pulley 242. The pulleys 241, 242 may be coupled to one another by a chain 245.

Each pulley 241, 242 may have a conical shape and include a fixed portion 246A, 247A coupled to an adjustable portion 246B, 247B, with the adjustable portions 246B, 247B coupled to the respective solenoids 243, 244. The fixed portion 246A of the input pulley 241 may be coupled to the engine output shaft 123 and the fixed portion 247A of the output pulley 242 may be coupled to the alternator input 136. The solenoids 243, 244 can act on the pulleys 241, 242 by displacing the adjustable portions 246B, 247B to adjust a gear ratio between the pulleys 241, 242, as is known. The gear ratio between the pulleys 241, 242 determines a rotation speed of the alternator input 136, and thus the electrical output of the alternator 134, relative to a rotation speed of the engine output shaft 123. It should be appreciated that, in some embodiments, only one solenoid 243, 244 is provided that adjusts the gear ratio by only acting on the input pulley 241 or the output pulley 242.

A rotation speed sensor 250 is coupled to the output pulley 242 and/or the alternator input 136 and is configured to output a first signal corresponding to a rotation speed of the alternator input 136. In some embodiments, the rotation speed sensor 250 is coupled to the alternator input 136 by a sensor gear 251 that is rotatably coupled to both the rotation speed sensor 250 and the alternator input 136. The sensor gear 251 may, for example, be rotatably mounted on the alternator input 136 so the rotation speed of the alternator input 136 is a rotation speed of the sensor gear 251, which the rotation speed sensor 250 can sense to output the first signal. Alternatively, the rotation speed sensor 250 can be coupled to the output pulley 242 and configured to sense a rotation speed of the output pulley 242, which drives rotation of the alternator input 136, and output the first signal corresponding to the rotation speed of the alternator input 136 based on the rotation speed of the output pulley 242.

The work vehicle 100 further includes a controller 160 (illustrated in FIG. 1) that is operatively coupled to the solenoids 243, 244 and the rotational speed sensor 250. The controller 160 may be a system controller of the work vehicle 100 that controls the functions of several different components and/or systems of the work vehicle 100, or a specific controller that only controls functions of the alternator assembly 133, based on operative connections with other components of the work vehicle 100 and instructions stored in a memory 161 of the controller 160. The controller 160 is configured to receive the output first signal from the rotation speed sensor 250, determine the rotation speed of the alternator input 136 based on the received first signal, compare the rotation speed of the alternator input 136 to a set rotation speed, and output an adjustment signal to at least one of the solenoids 243, 244 if the rotation speed of the alternator input 136 differs from the set rotation speed so at least one of the solenoids 243, 244 adjusts the gear ratio between the input pulley 241 and the output pulley 242 such that the rotation speed of the alternator input 136 is equal to the set rotation speed. The set rotation speed may be, for example, a rotation speed at which the alternator 134 is configured to generate a maximum electrical current from rotational motion of the alternator input 136, with the maximum electrical current being output to the battery 132. Alternatively, the set rotation speed may be a rotation speed at which the electrical current output of the alternator 134 is equal to a minimum electrical current needed to supply the electrical components of the work vehicle 100 with sufficient electrical power to function.

For example, if the set rotation speed of the alternator input 136 is 2600 rotations per minute (RPM) and the controller 160 determines that the rotation speed of the alternator input 136 is 1300 RPM, the controller 160 can output an adjustment signal to one of the solenoids, such as the second solenoid 244, to adjust the gear ratio between the input pulley 241 and the output pulley 242 by 2:1 so the output pulley 242, and thus the alternator input 136, rotates at double the current rotation speed, i.e., at the set rotation speed. While the previously described example is directed toward a scenario where the output alternator current is too low before adjustment of the gear ratio, the controller 160 can also be configured to adjust the gear ratio between the pulleys 241, 242 to lower the rotation speed of the alternator input 136 and avoid, for example, excessive rotation of the alternator input 136 at high rotation speeds of the engine output shaft 123. Thus, it should be appreciated that the controller 160 can adjust the gear ratio between the pulleys 241, 242 via the solenoid(s) 243, 244 so the alternator 134 can output a set amount of electrical current independently of the rotation speed of the engine 122. In some embodiments, the controller 160 is configured to only output the adjustment signal if the rotation speed of the alternator input 136 is below the set rotation speed.

The controller 160 can determine and store the gear ratio between the pulleys 241, 242 in a variety of ways. For example, the controller 160 can be operatively coupled to an input rotation speed sensor 248 that is coupled with the engine output shaft 123 and/or the input pulley 241 and configured to output a second signal corresponding to a rotation speed of the input pulley 241. The controller 160 can be configured to receive the output second signal, determine the rotation speed of the input pulley 241, and determine a current gear ratio between the input pulley 241 and the output pulley 242 based at least partially on a ratio between the rotation speed of the input pulley 241 and the rotation speed of the alternator input 136. Alternatively, the controller 160 can determine the current gear ratio based on a ratio between the rotation speed of the input pulley 241 and a rotation speed of the output pulley 242, which the controller 160 can determine directly from the rotation speed sensor 250 or indirectly based on the rotation speed of the alternator input 136. The controller 160 may then calculate a new gear ratio where the rotation speed of the alternator input 136 is equal to the set rotation speed based at least partially on the determined current gear ratio and the rotation speed of the alternator input 136 and output the adjustment signal to the solenoid(s) 243, 244 to adjust the current gear ratio between the pulleys 241, 242 to the new gear ratio so the rotation speed of the alternator input 136 is equal to the set rotation speed. Such an embodiment allows the controller 160 to signal for gear ratio adjustment by monitoring the rotation speed of the transmission input (at the input pulley 241) and the rotation speed of the transmission output (at the alternator input 136).

Alternatively, the controller 160 can be operatively coupled to an engine speed sensor 249 that is coupled to the engine output shaft 123 and configured to output a third signal corresponding to a rotation speed of the engine output shaft 123. The controller 160 can be further configured to receive the output third signal, determine the rotation speed of the engine output shaft 123 based on the received third signal, and determine a current effective gear ratio between the input pulley 241 and the output pulley 242 based at least partially on a ratio between the rotation speed of the engine output shaft 123 and the rotation speed of the alternator input 136. The controller 160 can then calculate a new gear ratio where the rotation speed of the alternator input 136 is equal to the set rotation speed based at least partially on the current effective gear ratio and the rotation speed of the alternator input 136 and output the adjustment signal to at least one of the solenoids 243, 244 to adjust the current effective gear ratio to the new gear ratio. Such an embodiment allows the controller 160 to signal for gear ratio adjustment by monitoring the rotation speed of the engine 122 (at the engine output shaft 123) and the rotation speed of the transmission output (at the alternator input 136), which can be used to correlate the effective gear ratio of the variable transmission assembly 140 from the engine 122 to the alternator 134.

Alternatively, the controller 160 can determine the gear ratio based on a position of one or both of the solenoids 243, 244. The controller 160 can then output the adjustment signal to at least one of the solenoids 243, 244 to adjust the gear ratio between the pulleys 241, 242 so the rotation speed of the alternator input 136 is equal to the set rotation speed. Such an embodiment allows the controller 160 to determine the gear ratio based on output from sensors that may be embedded in the solenoids 243, 244. It should be appreciated that the previously described ways of the controller 160 determining the adjustment of the gear ratio needed so the rotation speed of the alternator input 136 is equal to the set rotation speed are exemplary only, and there are various other ways of configuring the controller 160 so the controller 160 can signal for the solenoid(s) 243, 244 to adjust the gear ratio so the rotation speed of the alternator input 136 is equal to the set rotation speed.

From the foregoing, it should be appreciated that the alternator assembly 133 with the variable transmission assembly 140, rotation speed sensor 250, and controller 160 provided according to the present disclosure can output a consistent electrical current from the alternator 134 independently of the rotation speed of the engine 122. This consistency can avoid electrical components not having sufficient electrical power to function when, for example, the engine 122 is idling. The controller 160 can be configured, for example, to adjust the gear ratio between the pulleys 241, 242 so the electrical current output of the alternator 134 is always at a maximum to power the electrical components of the work vehicle 100. Further, this consistency can avoid excessive rotation of the alternator input 136 at high engine speeds to reduce the wear experienced by the alternator 134.

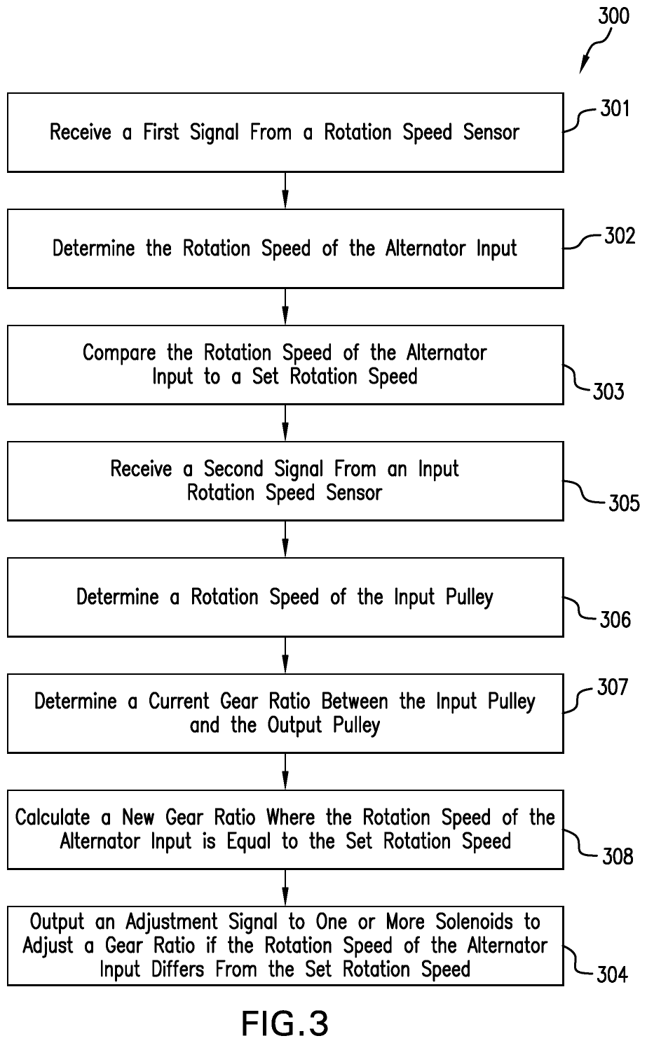

Referring now to FIG. 3, an exemplary embodiment of a method 300 for maintaining electrical current output of the alternator 134 of the work vehicle 100 provided in accordance with the present disclosure is illustrated. The method 300 may be performed by the previously described controller 160 and includes receiving 301 a first signal from the rotation speed sensor 250 coupled to the output pulley 242 and/or the alternator input 136, with the first signal corresponding to the rotation speed of the alternator input 136. The method 300 further includes determining 302 the rotation speed of the alternator input 136 based on the received first signal and comparing 303 the rotation speed of the alternator input 136 to a set rotation speed, as previously described. If the rotation speed of the alternator input 136 differs from the set rotation speed, the controller 160 outputs 304 the adjustment signal to at least one of the solenoids 243, 244 so the solenoid(s) 243, 244 adjusts the gear ratio between the input pulley 241 and the output pulley 242 such that the rotation speed of the alternator input 136 is equal to the set rotation speed. In some embodiments, the method 300 further includes receiving 305 the second signal from the input rotation speed sensor 248, the second signal corresponding to the rotation speed of the input pulley 241, determining 306 the rotation speed of the input pulley 241, and determining 307 a current gear ratio between the input pulley 241 and the output pulley 242 based at least partially on a ratio between the rotation speed of the input pulley 241 and the rotation speed of the alternator input 136. The method 300 may further include calculating 308 a new gear ratio where the rotation speed of the alternator input 136 is equal to the set rotation speed based at least partially on the current gear ratio and the rotation speed of the alternator input 136, in which case outputting 304 the adjustment signal to the solenoid(s) 243, 244 can cause the solenoid(s) 243, 244 to adjust the current gear ratio to the new gear ratio. The set rotation speed may be, for example, the rotation speed at which the alternator 134 is configured to generate the maximum electrical current from rotational motion of the alternator input 136.

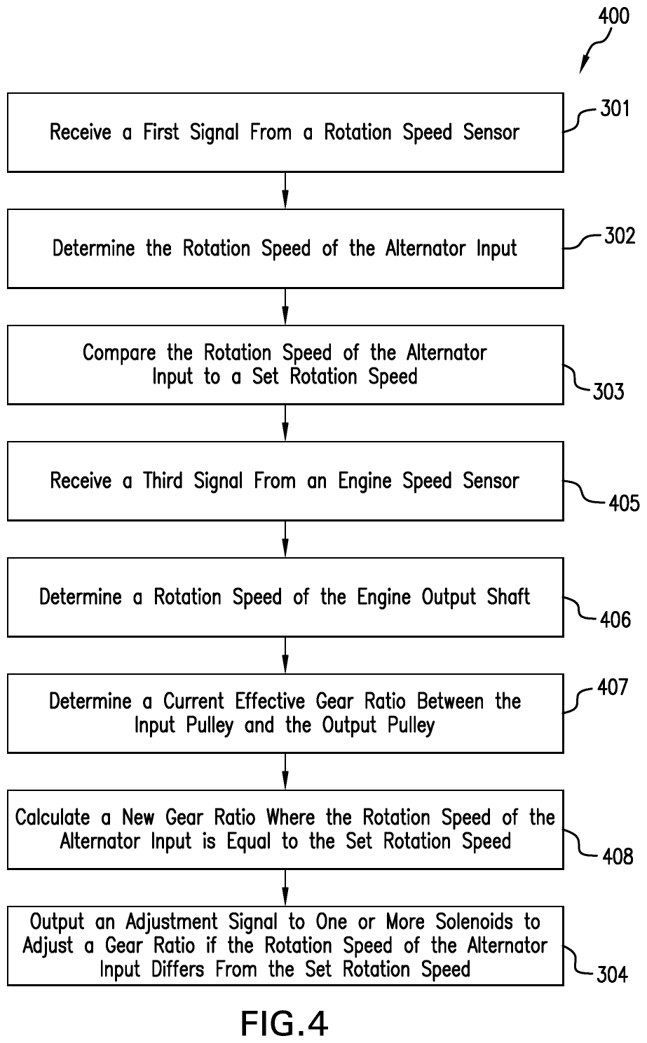

Another exemplary embodiment of a method 400 for maintaining electrical current output of the alternator 134 of the work vehicle 100 provided in accordance with the present disclosure is illustrated in FIG. 4. The method 400 is similar to the method 300 in that the method 400 includes steps 301, 302, 303, and 304, but differs in that the method 400 further includes receiving 405 a third signal from the engine speed sensor 249, the third signal corresponding to the rotation speed of the engine output shaft 123, determining 406 the rotation speed of the engine output shaft 123 based on the received third signal, and determining 407 the current effective gear ratio between the input pulley 241 and the output pulley 242 based at least partially on the ratio between the rotation speed of the engine output shaft 123 and the rotation speed of the alternator input 136. The controller 160 can then calculate 408 a new gear ratio where the rotation speed of the alternator input 136 is equal to the set rotation speed based at least partially on the current effective gear ratio and the rotation speed of the alternator input 136, with the output adjustment signal causing the solenoid(s) 243, 244 to adjust the current effective gear ratio to the new gear ratio.

It is to be understood that the steps of the methods 300 and 400 are performed by the controller 160 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 160 described herein, such as the methods 300 and 400, is implemented in software code or instructions which are tangibly stored on a tangible computer readable medium. The controller 160 loads the software code or instructions via a direct interface with the computer readable medium or via a wired and/or wireless network. Upon loading and executing such software code or instructions by the controller 160, the controller 160 may perform any of the functionality of the controller 160 described herein, including any steps of the methods 300 and 400 described herein.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. An alternator assembly for a work vehicle, comprising:
an alternator comprising an alternator input, the alternator being configured to convert rotational motion of the alternator input into electrical current;
a variable transmission assembly comprising an input pulley, an output pulley coupled to the input pulley and the alternator input, and at least one solenoid configured to act on at least one of the input pulley or the output pulley to adjust a gear ratio between the input pulley and the output pulley;
a rotation speed sensor coupled with at least one of the output pulley or the alternator input and configured to output a first signal corresponding to a rotation speed of the alternator input; and
a controller operatively coupled to the at least one solenoid and the rotational speed sensor, the controller being configured to:
receive the output first signal;
determine the rotation speed of the alternator input based on the received first signal;
compare the rotation speed of the alternator input to a set rotation speed; and
output an adjustment signal to the at least one solenoid if the rotation speed of the alternator input differs from the set rotation speed so the at least one solenoid adjusts the gear ratio such that the rotation speed of the alternator input is equal to the set rotation speed.

2. The alternator assembly of claim 1, wherein the variable transmission assembly further comprises a transmission input coupled to the input pulley and an input rotation speed sensor coupled with at least one of the transmission input or the input pulley and configured to output a second signal corresponding to a rotation speed of the input pulley, the controller being further configured to:
receive the output second signal;
determine the rotation speed of the input pulley based on the received second signal; and
determine a current gear ratio between the input pulley and the output pulley based at least partially on a ratio between the rotation speed of the input pulley and the rotation speed of the alternator input.

3. The alternator assembly of claim 2, wherein the controller is further configured to calculate a new gear ratio where the rotation speed of the alternator input is equal to the set rotation speed based at least partially on the current gear ratio and the rotation speed of the alternator input, wherein outputting the adjustment signal to the at least one solenoid adjusts the current gear ratio to the new gear ratio.

4. The alternator assembly of claim 1, wherein the at least one solenoid comprises a first solenoid coupled to the input pulley and a second solenoid coupled to the output pulley, the controller being operatively coupled to the first solenoid and the second solenoid.

5. The alternator assembly of claim 1, wherein the set rotation speed is a rotation speed at which the alternator is configured to generate a maximum electrical current from rotational motion of the alternator input.

6. The alternator assembly of claim 1, further comprising a sensor gear rotatably coupled to the alternator input and the rotation speed sensor.

7. A work vehicle, comprising:
a chassis;
an engine carried by the chassis and comprising an engine output shaft;
a battery carried by the chassis;
an alternator electrically coupled to the battery and comprising an alternator input, the alternator being configured to convert rotational motion of the alternator input into electrical current that is output to the battery;
a variable transmission assembly comprising an input pulley coupled to the engine output shaft, an output pulley coupled to the input pulley and the alternator input, and at least one solenoid configured to act on at least one of the input pulley or the output pulley to adjust a gear ratio between the input pulley and the output pulley;
a rotation speed sensor coupled with at least one of the output pulley or the alternator input and configured to output a first signal corresponding to a rotation speed of the alternator input; and
a controller operatively coupled to the at least one solenoid and the rotational speed sensor, the controller being configured to:
receive the output first signal;
determine the rotation speed of the alternator input based on the received first signal;
compare the rotation speed of the alternator input to a set rotation speed; and
output an adjustment signal to the at least one solenoid if the rotation speed of the alternator input differs from the set rotation speed so the at least one solenoid adjusts the gear ratio such that the rotation speed of the alternator input is equal to the set rotation speed.

8. The work vehicle of claim 7, wherein the variable transmission assembly further comprises an input rotation speed sensor coupled with at least one of the engine output shaft or the input pulley and configured to output a second signal corresponding to a rotation speed of the input pulley, the controller being further configured to:
receive the output second signal;
determine the rotation speed of the input pulley based on the received second signal; and
determine a current gear ratio between the input pulley and the output pulley based at least partially on a ratio between the rotation speed of the input pulley and the rotation speed of the alternator input.

9. The work vehicle of claim 8, wherein the controller is further configured to calculate a new gear ratio where the rotation speed of the alternator input is equal to the set rotation speed based at least partially on the current gear ratio and the rotation speed of the alternator input, wherein outputting the adjustment signal to the at least one solenoid adjusts the current gear ratio to the new gear ratio.

10. The work vehicle of claim 7, wherein the at least one solenoid comprises a first solenoid coupled to the input pulley and a second solenoid coupled to the output pulley, the controller being operatively coupled to the first solenoid and the second solenoid.

11. The work vehicle of claim 7, wherein the set rotation speed is a rotation speed at which the alternator is configured to generate a maximum electrical current from rotational motion of the alternator input, the maximum electrical current being output to the battery.

12. The work vehicle of claim 7, further comprising a sensor gear rotatably coupled to the alternator input and the rotation speed sensor.

13. The work vehicle of claim 7, further comprising an engine speed sensor coupled to the engine output shaft and configured to output a third signal corresponding to a rotation speed of the engine output shaft, the controller being operatively coupled to the engine speed sensor and being configured to:
receive the output third signal;
determine the rotation speed of the engine output shaft based on the received third signal; and
determine a current effective gear ratio between the input pulley and the output pulley based at least partially on a ratio between the rotation speed of the engine output shaft and the rotation speed of the alternator input.

14. The work vehicle of claim 13, wherein the controller is further configured to:
calculate a new gear ratio where the rotation speed of the alternator input is equal to the set rotation speed based at least partially on the current effective gear ratio and the rotation speed of the alternator input, wherein outputting the adjustment signal to the at least one solenoid adjusts the current effective gear ratio to the new gear ratio.

15. A method for maintaining electrical current output of an alternator of a work vehicle, the alternator comprising an alternator input that is coupled to an output pulley of a variable transmission assembly, the output pulley being coupled to an input pulley, the method being performed by a controller and comprising:
receiving a first signal from a rotation speed sensor coupled to at least one of the output pulley or the alternator input, the first signal corresponding to a rotation speed of the alternator input;
determining the rotation speed of the alternator input based on the received first signal;
comparing the rotation speed of the alternator input to a set rotation speed; and
outputting an adjustment signal to at least one solenoid if the rotation speed of the alternator input differs from the set rotation speed so the at least one solenoid adjusts a gear ratio between the input pulley and the output pulley such that the rotation speed of the alternator input is equal to the set rotation speed.

16. The method of claim 15, further comprising:
receiving a second signal from an input rotation speed sensor coupled with at least one of the input pulley or a transmission input coupled to the input pulley, the second signal corresponding to a rotation speed of the transmission input;
determining the rotation speed of the transmission input; and
determining a current gear ratio between the first pulley and the second pulley based at least partially on a ratio between the rotation speed of the transmission input and the rotation speed of the alternator input.

17. The method of claim 16, further comprising:
calculating a new gear ratio where the rotation speed of the alternator input is equal to the set rotation speed based at least partially on the current gear ratio and the rotation speed of the alternator input, wherein outputting the adjustment signal to the at least one solenoid adjusts the current gear ratio to the new gear ratio.

18. The method of claim 15, wherein the set rotation speed is a rotation speed at which the alternator is configured to generate a maximum electrical current from rotational motion of the alternator input.
